(19) United States
(12) Patent Application Publication
(10) Pub. No.: US 2010/0301706 A1
(43) Pub. Date: Dec. 2, 2010

(54) DIFFERENTIAL PIEZOELECTRIC SENSOR

(75) Inventor: Daniel N. Koury, JR., Mesa, AZ (US)

Correspondence Address: MESCHKOW & GRESHAM, P.L.C., 7250 NORTH SIXTEENTH STREET, SUITE 318, PHOENIX, AZ, 85020-5279, US

(73) Assignee: FREESCALE SEMICONDUCTOR, INC., Austin, TX (US)

(21) Appl. No.: 12/472,506

(22) Filed: May 27, 2009

(51) Int. Cl. G01L 1/16

(52) U.S. Cl. 310/338

(57) ABSTRACT

A differential piezoelectric sensor (20) includes a suspended structure (24) coupled to a substrate (22). The suspended structure (24) has at least one location (44) in a first stress state (70) and at least one location (46) in a second stress state (72) when the suspended structure (24) is in a stress position (69). Piezoelectric elements (26) are located on the suspended structure (24) at the locations (44), each producing a signal (78) in response to mechanical stress (68) experienced by the suspended structure (24). In addition, piezoelectric elements (28) are formed on the suspended structure (24) at the locations (46), each producing a signal (80) in response to the mechanical stress (68). The piezoelectric elements (26, 28) are electrically connected to combine the signals (78, 80) so as to obtain a signal (76) representative of the mechanical stress (68) experienced by the suspended structure (24).

### TECHNICAL FIELD OF THE INVENTION

The present invention relates generally to piezoelectric sensors. More specifically, the present invention relates to piezoelectric sensor configurations with differential output and enhanced sensitivity.

### BACKGROUND OF THE INVENTION

Piezoelectric materials are used in a variety of sensors and actuators. Piezoelectric materials convert mechanical energy to electrical energy and vice versa. For instance, if a mechanical stress (e.g., force or pressure) is applied to a piezoelectric element, an electrical signal is generated in proportion to the mechanical stress thereby producing the function of a sensor. Generation of an electrical signal in response to an applied force or pressure is known as the “primary piezoelectric effect”. Similarly, if an electrical signal is applied to a piezoelectric element, it will expand in proportion as an actuator. Geometric deformation (expansion or contraction) in response to an applied electric signal is known as the “secondary piezoelectric effect.” Whether operated as a sensor or actuator, electrically conductive electrodes are appropriately placed on the piezoelectric crystal for collection or application of the electrical signal, respectively. Therefore, a piezoelectric sensor or actuator nominally includes a) a portion of piezoelectric material, and b) electrically-conductive electrodes suitably arranged to transfer electrical energy between the piezoelectric material and an electronic circuit.

A piezoelectric sensor can use the piezoelectric effect to measure pressure, acceleration, strain, or force by converting them to an electrical signal. The sensitivity of a piezoelectric sensor is the minimum magnitude of input signal required to produce a specified output electrical signal having a specified signal-to-noise ratio. Thus, the sensitivity is a ratio of the output signal to the input signal. Piezoelectric sensors that are highly sensitive are advantageous in a variety of environments in which the input signal (e.g., deflection due to mechanical stress) may be low and/or in a high noise environment. Such environments in which piezoelectric sensors have shown to be versatile tools include various process environments, sensing environments, health monitoring, and the like.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a differential piezoelectric sensor in accordance with an embodiment of the invention;

FIG. 2 shows a side view of the differential piezoelectric sensor of FIG. 1;

FIG. 3 shows a circuit diagram exemplifying an output voltage produced by the piezoelectric sensor of FIG. 1;

FIG. 4 shows a circuit diagram exemplifying an output current produced by the piezoelectric sensor of FIG. 1;

FIG. 5 shows a perspective view of a differential piezoelectric sensor in accordance with another embodiment of the invention;

FIG. 6 shows a side view of the differential piezoelectric sensor of FIG. 5;

FIG. 7 shows a top view of a differential piezoelectric sensor in accordance with another embodiment of the invention;

FIG. 8 shows a side view of the differential piezoelectric sensor of FIG. 7; and

FIG. 9 shows a side view of a differential piezoelectric sensor in accordance with another embodiment of the invention.

### DETAILED DESCRIPTION

Embodiments of the invention entail differential piezoelectric sensors in which sensor geometry is optimized to effectively increase sensor reliability, durability, and sensitivity relative to prior art designs. Moreover, in accordance with embodiments of the invention, the differential sensors can be manufactured cost effectively, and they can be miniaturized so as to reduce the effects of structural dynamics, and yet still have acceptable sensitivity. Thus, the differential piezoelectric sensors may be readily implemented within the increasingly complex and miniaturized modern mechanical and electromechanical systems, as well as in a wide variety of processes, sensing applications, health monitoring applications, and the like.

In addition, the differential piezoelectric sensors may be implemented for energy generation, known as energy harvesting or energy scavenging, in which energy is captured and stored. Such an application is being developed in connection with small, wireless autonomous devices, like those used in wearable electronics and/or in wireless sensor networks. Energy harvesting devices, implemented using the differential piezoelectric sensor geometries described below, may not produce sufficient energy to perform mechanical work, but instead may provide very small amount of power for powering low-energy electronics or to charge a battery.

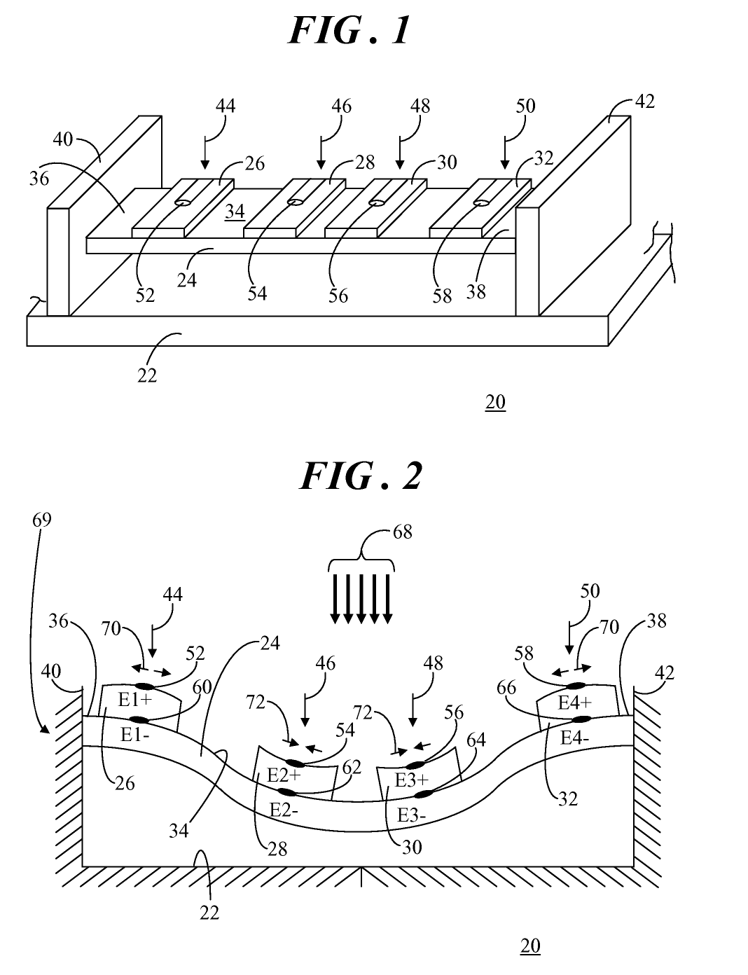

Referring to FIGS. 1 and 2, FIG. 1 shows a perspective view of a differential piezoelectric sensor 20 in accordance with an embodiment of the invention and FIG. 2 shows a side view of differential piezoelectric sensor 20. Differential piezoelectric sensor 20 includes a substrate 22 and a suspended structure 24 coupled to substrate 22. Piezoelectric elements 26, 28, 30, and 32 are formed on a surface 34 of suspended structure 24.

Suspended structure 24 includes opposing ends 36 and 38. In an embodiment, an anchor 40 fixes, i.e., anchors, end 36 of suspended structure 24 to substrate 22, and an anchor 42 fixes, i.e., anchors, end 38 of suspended structure 24 to substrate 22 so that the remainder of suspended structure 24 between ends 36 and 38 is spaced apart from substrate 22 in a suspended bridge configuration. The suspended configuration of structure 24 and anchors 40, 42 may be formed through deposition, patterning, and selective removal of material layers using conventional and upcoming microfabrication and semiconductor process technologies. Anchors 40 and 42 are shown schematically as “built in” constraints. However, it should be clear to those skilled in the art that a variety of anchor structures may be used so that ends 36 and 38 of suspended structure 24 are constrained to move much less then the middle portion of suspended structure 24 where piezoelectric elements 28 and 30 are located.

In the illustrated embodiment, piezoelectric element 26 is formed on surface 34 of structure 24 at a location 44. Likewise, piezoelectric element 28 is formed on surface 34 at a location 46. Piezoelectric element 30 is formed on surface 34 at a location 48, and piezoelectric element 32 is formed on surface 34 at a location 50. Piezoelectric elements 26, 28, 30, and 32 may be formed on suspended structure 24 using a thin film deposition technique followed by selective etching to leave the isolated, or separate, piezoelectric elements 26, 28, 30, and 32. Piezoelectric elements 26, 28, 30, 32 may be formed from known and upcoming piezoelectric crystals, piezoelectric ceramics, piezoelectric polymers, and the like.

Each of piezoelectric elements 26, 28, 30, 32 has a corresponding outer electrode 52, 54, 56, and 58 (labeled En+, where n=1,2,3,4), visible in FIG. 2. Likewise, each of piezoelectric elements 26, 28, 30, 32 has a corresponding inner electrode 60, 62, 64, and 66 (labeled En−, where n=1, 2, 3, 4). Outer electrodes 52, 54, 56, and 58 and inner electrodes 60, 62, 64, and 66 can be placed at any appropriate location on top and bottom surfaces of piezoelectric elements 26, 28, 30, and 32 and their traces may be run from the surfaces to a sensor output (not shown) via the top or bottom surfaces of suspended structure 24 and anchors 40 and/or 42. It should be understood that the term “outer electrode” refers to a location on the surface of each of piezoelectric elements 26, 28, 30, 32 that is displaced from suspended structure 24. The term “inner electrode” refers to a location on the surface of each of piezoelectric elements 26, 28, 30, 32 that is in contact with surface 34 of suspended structure 24. The outer and inner electrodes may be formed from various conductive materials utilized in micromachining processes.

In an exemplary embodiment, inner electrodes 60, 62, 64, and 66 can be formed on surface 34 of suspended structure 24 prior to forming piezoelectric elements 26, 28, 30, and 32 on surface 34 using deposition, patterning, and etching techniques. Inner electrodes 60, 62, 64, and 66 may be larger than their corresponding piezoelectric elements 26, 28, 30, and 32 to provide a single material surface for deposition of the piezoelectric material that will later form elements 26, 28, 30, and 32. Following formation of piezoelectric elements 26, 28, 30, and 32, outer electrodes 52, 54, 56, and 58 may then be formed on piezoelectric elements 26, 28, 30, and 32 using deposition, patterning, and etching techniques. In another exemplary embodiment, outer electrodes 52, 54, 56, and 58 and inner electrodes 60, 62, 64, and 66 may be coupled to respective piezoelectric elements 26, 28, 30, and 32 via bonding pads or the like.

In an embodiment, suspended structure 24 may be formed from a silicon nitride material. Silicon nitride has good shock resistance and other advantageous mechanical and thermal properties. Therefore, suspended structure 24 is resistant to fracture under conditions of high forces, e.g., acceleration, impact, and so forth. Silicon nitride is typically tensile as deposited. This tension will tend to make suspended structure 24 more flat, or planar, when structure 24 is supported by anchors 40 and 42 at opposing ends 36 and 38. The planarity of suspended structure 24 can minimize curvature due to multiple deposited layers of films with different “as-deposited” stresses. The planarity may additionally reduce the temperature variation of curvature due to the different thermal expansion coefficients of the stacked layers of films.

As shown in exaggerated form in FIG. 2, when sensor 20 is subjected to an external stimulus, such as acceleration or a pressure difference, suspended structure 24 will tend to deflect or bend in response to the external stimulus. The external stimulus to which suspended structure 24 is subjected is represented by downward directed arrows 68. Thus, the external stimulus is referred to hereinafter as external stimulus 68. The stress position, i.e., deflection or movement of suspended structure 24, caused by external stimulus 68 is represented by the exaggerated curved appearance of suspended structure 24 and is referred to hereinafter as a stress position 69. Due to the coupling of ends 36 and 38 of suspended structure 24 to substrate 22 via anchors 40 and 42, when suspended structure 24 is in stress position 69, regions of suspended structure 24 will be in a first stress state, referred to herein as a tensile stress state, represented by a pair of arrows 70 facing away from one another. In addition, other regions of suspended structure 24 will be in a second stress state, referred to herein as a compressive stress state, represented by a pair of arrows 72 facing one another. With external stimulus 68 in the downward direction as shown so that suspended structure 24 is in a downwardly bowed stress position 69, locations 44 and 50 on surface 34 of suspended structure 24 are in tensile stress state 70 and locations 46 and 48 are in compressive stress state 72.

Of course, it should be readily apparent that when external stimulus 68 is in the upward direction (not shown) locations 44 and 50 will be in compressive stress state 72 and locations 46 and 48 will be in tensile stress state 70. Nevertheless, the following discussion applies equivalently to a scenario in which the external stimulus is oriented opposite from that which is shown.

It should be recalled that each of the piezoelectric elements generates an electrical signal, e.g., an output signal, which depends on the magnitude of external stimulus 68 causing stress position 69 of suspended substrate 24. However, since piezoelectric elements 26 and 32 are in tension and piezoelectric elements 28 and 30 are in compression, their generated output signals will be opposite in signal polarity. In accordance with an embodiment, outer electrodes 52, 54, 56, and 58 and inner electrodes 60, 62, 64, and 66 are appropriately electrically coupled so that each of the output signals will combine, i.e., add, instead of cancel, as discussed below.

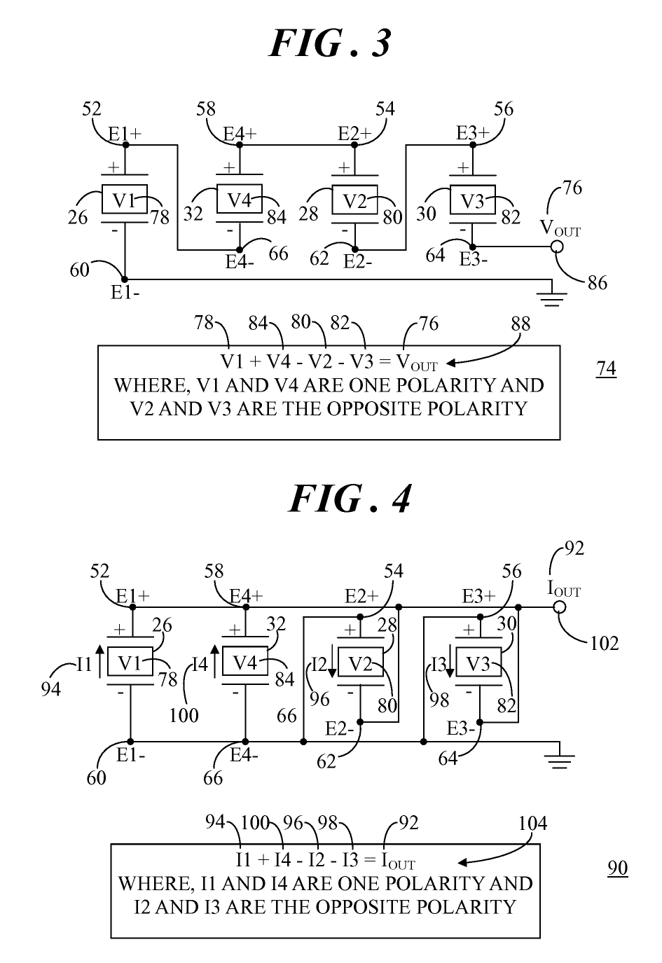

FIG. 3 shows a circuit diagram 74 exemplifying an output voltage 76 produced by piezoelectric sensor 20 (FIG. 1). Piezoelectric element 26 produces a voltage signal 78, labeled V1, in response to the mechanical stress experienced by suspended structure 24 when suspended structure 24 is in stress position 69 (FIG. 2) resulting from the application of external stimulus 68 (FIG. 2). Likewise, piezoelectric element 28 produces a voltage signal 80, labeled V2, piezoelectric element 30 produces a voltage signal 82, labeled V3, and piezoelectric element 32 produces a voltage signal 84, labeled V4, in response to the mechanical stress experienced by suspended structure 24 when suspended structure is in stress position 69 (FIG. 2) resulting from the application of external stimulus 68 (FIG. 2).

Piezoelectric elements 26 and 32 are in the first stress state, e.g., tensile stress state 70 (FIG. 2), and piezoelectric elements 28 and 30 are in the second stress state, e.g., compressive stress state 72 (FIG. 2). Since they are in opposing stress states, voltage signals 78 and 84 of respective piezoelectric elements 26 and 32 will be opposite in signal polarity from voltage signals 80 and 82 of respective piezoelectric elements 28 and 30.

In accordance with an embodiment, piezoelectric elements 26, 28, 30, and 32 are electrically coupled serially and to yield a common, i.e., the same, polarity for each of voltage signals 78, 80, 82, and 84. To that end, outer electrode 52 (i.e., a positive electrode in an embodiment) of piezoelectric element 26 is electrically coupled to inner electrode 66 (i.e., a negative electrode in an embodiment) of piezoelectric element 32 since voltage signals 78 and 84 have the same polarity, and inner electrode 60 of piezoelectric element 26 is electrically coupled to ground. However, voltage signals 80 and 82 are opposite in polarity from voltage signals 78 and 84. Thus, outer electrode 58 (i.e., a positive electrode in an embodiment) of piezoelectric element 32 is electrically coupled to outer electrode 54 (i.e., a positive electrode in an embodiment) of piezoelectric element 28. Inner electrode 62 (i.e., a negative electrode in an embodiment) of piezoelectric element 28 is electrically coupled to outer electrode 56 (i.e., a positive electrode in an embodiment) of piezoelectric element 30, and inner electrode 64 (i.e., a negative electrode in an embodiment) of piezoelectric element 30 is electrically coupled to an output voltage terminal 86. Hence, outer electrodes 52, 54, 56, and 58 may alternatively be referred to hereinafter as positive electrodes 52, 54, 56, and 58. Similarly, inner electrodes 60, 62, 64, and 66 may alternatively be referred to hereinafter as negative electrodes 60, 62, 64, and 66.

The differential and serial mode of electrical connections of piezoelectric elements 26, 28, 30, and 32 produces output voltage 76 representative of the mechanical stress experienced by suspended structure 24 that is significantly greater than, e.g., approximately quadruple, that of a single one of voltage signals 78, 80, 82, and 84. This additive effect is represented by an equation 88 in which a common polarity is produced for each of voltage signals 78, 80, 82, and 84 and voltage signals 78, 80, 82, and 84 are added, i.e., summed, to obtain output voltage 76. In addition, more complicated connections can be used to provide enhanced noise cancellation, thereby improving the signal-to-noise ratio. For example, a fixed voltage can be applied to electrodes 52 and 58 (FIG. 3) and electrode 60 and terminal 86 can be used as a differential voltage output from sensor 20. A “bridge” configuration may be another connection option for providing enhanced noise cancellation. The combined effects of adding voltage signals 78, 80, 82, and 84 and improved signal-to-noise ratio results in increased sensitivity of piezoelectric sensor 20 relative to prior art configurations.

FIG. 4 shows a circuit diagram 90 exemplifying an output current 92 produced by piezoelectric sensor 20 (FIG. 1). Some piezoelectric materials may produce a proportionately higher current signal than voltage signal. Accordingly, in some embodiments, piezoelectric elements 26, 28, 30, and 32 may be electrically connected to yield a common polarity for current signals so as to achieve a maximum output current. Circuit diagram 90 illustrates parallel electrical connection of piezoelectric elements 26, 28, 30, and 32 to yield output current 92. Piezoelectric element 26 produces a current signal 94 in response to the mechanical stress experienced by suspended structure 24 when suspended structure 24 is in stress position 69. Likewise, piezoelectric element 28 produces a current signal 96, piezoelectric element 30 produces a current signal 98, and piezoelectric element 32 produces a current signal 100 in response to the mechanical stress experienced by suspended structure 24 when suspended structure 24 is in stress position 69 (FIG. 2) resulting from external stimulus 68 (FIG. 2).

In accordance with an embodiment, piezoelectric elements 26, 28, 30, and 32 are electrically coupled in parallel and to yield a common, i.e., the same, polarity for each of current signals 94, 96, 98, and 100. To that end, outer electrode 52 of piezoelectric element 26 is electrically coupled to outer electrode 58 of piezoelectric element 32 since voltage signals 78 and 84, and consequently current signals 94 and 100 have the same polarity. Inner electrode 60 of piezoelectric element 26 and inner electrode 66 of piezoelectric element 32 are electrically connected to ground. However, voltage signals 80 and 82, and consequently current signals 96 and 98, are opposite in polarity from voltage signals 78 and 84, and consequently current signals 94 and 100. Thus, outer electrode 54 of piezoelectric element 28 and outer electrode 56 of piezoelectric element 30 are electrically connected to ground. However, inner electrode 62 of piezoelectric element 28 and inner electrode 64 of piezoelectric element 30 are electrically connected with outer electrodes 52 and 58 of respective piezoelectric element 26 and 32. Due to this parallel differential connection, outer electrodes 52 and 58 of respective piezoelectric elements 26 and 32 and inner electrodes 62 and 64 of respective piezoelectric elements 28 and 30 are all electrically connected to an output current terminal 102. Furthermore, inner electrodes 60 and 66 of respective piezoelectric elements 26 and 32 and outer electrodes 54 and 56 of respective piezoelectric elements 28 and 30 are electrically connected to ground. It should be apparent to those skilled in the art that the “GROUND” and “I_{OUT}” labels of FIG. 4 are arbitrary and could be switched to obtain the opposite polarity of current. Other connections are also possible to obtain better noise cancellation for certain applications, as discussed previously for the voltage output.

The differential and parallel mode of electrical connections of piezoelectric elements 26, 28, 30, and 32 yields output current 92, representative of the mechanical stress experienced by suspended structure 24 resulting from the application of external stimulus 68 (FIG. 2), that is significantly greater than, e.g., approximately quadruple, that of a single one of current signals 94, 96, 98, and 100. This additive effect is represented by an equation 104 in which a common polarity is obtained for each of current signals 94, 96, 98, and 100, and current signals 94, 96, 98, and 100 are added, i.e., summed, for each of piezoelectric elements 26, 28, 30, and 32 to yield differential output current 92. In addition, the mode of electrical connections again results in cancellation of induced noise that is present in all piezoelectric elements 26, 28, 30, and 32, thereby improving the signal-to-noise ratio of piezoelectric sensor 20. The combined effects of adding parallel current signals 94, 96, 98, and 100 and improved signal-to-noise ratio results in increased sensitivity of piezoelectric sensor 20 relative to prior art configurations.

The above description relates to a piezoelectric sensor in a suspended bridge configuration having four piezoelectric elements (two in compression and two in tension) when suspended structure 24 (FIG. 1) is in stress position 69 (FIG. 2) upon application of external stimulus 68 (FIG. 2). The four piezoelectric elements are strategically electrically coupled in series and to combine each of the voltage signals produced by each of the four piezoelectric elements to effectively obtain an output voltage that is significantly greater than that which may be produced by a single piezoelectric element. Alternatively, the four piezoelectric elements are strategically electrically coupled in parallel to combine each of the current signals produced by each of the four piezoelectric elements to effectively obtain an output current that is significantly greater than that which may be produced by a single piezoelectric element.

In alternative embodiments, a piezoelectric sensor may include more than one piezoelectric element, but the total quantity of piezoelectric elements may be greater than or less than a total of four piezoelectric elements. In addition, the suspended structure may have alternative geometric configurations, some of which are discussed below. Regardless of the quantity of piezoelectric elements implemented in a piezoelectric sensor and the particular geometric configuration, embodiments of the invention call for strategic placement of the piezoelectric elements at those locations on the suspended structure that are in the first stress state, e.g., tensile stress state 70, and the second stress state, e.g., compressive stress state 72.

Additional exemplary geometric configurations are provided below for illustrative purposes. It should be understood that electrical coupling of the piezoelectric elements in these geometric configurations should be made in accordance with the principles discussed in connection with FIG. 3 to obtain a maximum output voltage or in connection with FIG. 4 to obtain a maximum output current. Accordingly, electrical interconnection of the piezoelectric elements will not be repeated in connection with the following figures for brevity.

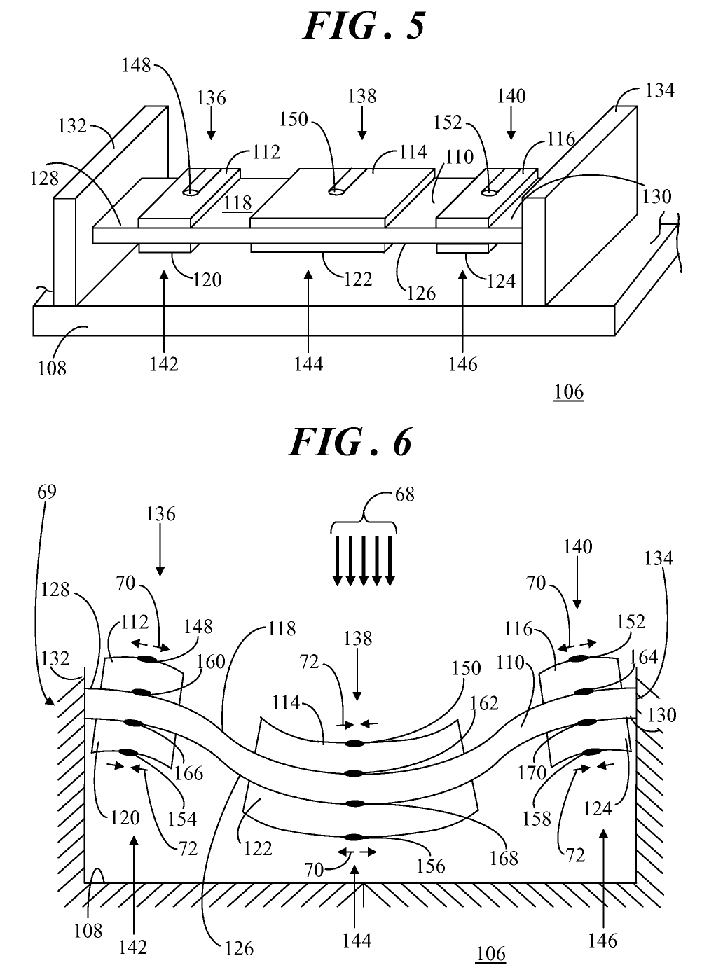

Referring to FIGS. 5-6, FIG. 5 shows a perspective view of a differential piezoelectric sensor 106 in accordance with another embodiment of the invention, and FIG. 6 shows a side view of differential piezoelectric sensor 106. Differential piezoelectric sensor 106 includes a substrate 108 and a suspended structure 110 coupled to substrate 108. Piezoelectric elements 112, 114, and 116 are located on a top surface 118 of suspended structure 110, and piezoelectric elements 120, 122, and 124 are located on a bottom surface 126 of suspended structure 110.

Suspended structure 110 includes opposing ends 128 and 130. In an embodiment, an anchor 132 fixes, i.e., anchors, end 128 of suspended structure 110 to substrate 108, and an anchor 134 fixes, i.e., anchors, end 130 of suspended structure 110 to substrate 108 so that suspended structure 110 is in a suspended bridge configuration.

In the illustrated embodiment, piezoelectric element 112 is formed on top surface 118 of structure 110 at a location 136. Likewise, piezoelectric element 114 is formed on top surface 118 at a location 138, and piezoelectric element 116 is located on top surface 118 at a location 140. In addition, piezoelectric element 120 is located on bottom surface 126 of structure 110 at a location 142. Likewise, piezoelectric element 122 is located on bottom surface 126 at a location 144, and piezoelectric element 124 is located on bottom surface 126 at a location 146. Suspended structure 110, anchors 132 and 134, and piezoelectric elements 112, 114, 116, 120, 122, and 124 may be formed using, for example, multiple layer deposition, patterning, and etching microfabrication processes, although other known and upcoming fabrication processes may alternatively be implemented.

Each of piezoelectric elements 112, 114, 116, 120, 122, and 124 has a corresponding outer electrode 148, 150, 152, 154, 156, and 158. Likewise, each of piezoelectric elements 112, 114, 116, 120, 122, and 124 has a corresponding inner electrode 160, 162, 164, 166, 168, and 170. Again, it should be understood that the term “outer electrode” refers to a location on the surface of each of piezoelectric elements 112, 114, 116, 120, 122, and 124 that is displaced from suspended structure 110 and the term “inner electrode” refers to a location on the surface of each of piezoelectric elements 112, 114, 116, 120, 122, and 124 that is in contact with corresponding top and bottom surfaces 118 and 126 of suspended structure 110. Outer electrodes 148, 150, 152, 154, 156, and 158 and inner electrodes 160, 162, 164, 166, 168, and 170 can be placed at any appropriate location on respective top and bottom surfaces of piezoelectric elements 112, 114, 116, 120, 122, and 124.

As shown in exaggerated form in FIG. 6, when sensor 106 is subjected to external stimulus 68, suspended structure 110 will move into stress position 69. That is, suspended structure 110 will flex or bend in response to external stimulus 68. Due to the coupling of ends 128 and 130 of suspended structure 110 to substrate 108 via anchors 132 and 134, regions of suspended structure 110 will be in the first stress state, e.g., tensile stress state 70 (represented by pairs of arrows facing away from one another). Other regions will be in the second stress state, e.g., compressive stress state 72 (represented by pairs of arrows facing one another). With external stimulus 68 in the downward direction as shown, locations 136 and 140 on top surface 118 and location 144 on bottom surface 126 of suspended structure 110 are in tensile stress state 70. In addition, location 138 on top surface 118 and locations 142 and 146 on bottom surface 126 of suspended structure 110 are in compressive stress state 72. Accordingly, piezoelectric elements 112, 116, and 122 are in tension and piezoelectric elements 138, 120, and 124 are in compression when suspended structure 110 is in stress position 69.

Since piezoelectric elements 112, 116, and 122 are in tension and piezoelectric elements 114, 120, and 124 are in compression, their generated output voltage signals will be opposite in polarity. In accordance with an embodiment, outer electrodes 148, 150, 152, 154, 156, and 158 and inner electrodes 160, 162, 164, 166, 168, and 170 are appropriately electrically coupled to obtain a common, i.e., the same, polarity for each of the voltage signals from piezoelectric elements 112, 114, 116, 120, 122, and 124 so that each of the voltage signals will add instead of cancel, as discussed in connection with FIG. 3. Alternatively, outer electrodes 148, 150, 152, 154, 156, and 158 and inner electrodes 160, 162, 164, 166, 168, and 170 may be appropriately electrically coupled so that each of the current signals will add instead of cancel, as discussed in connection with FIG. 4.

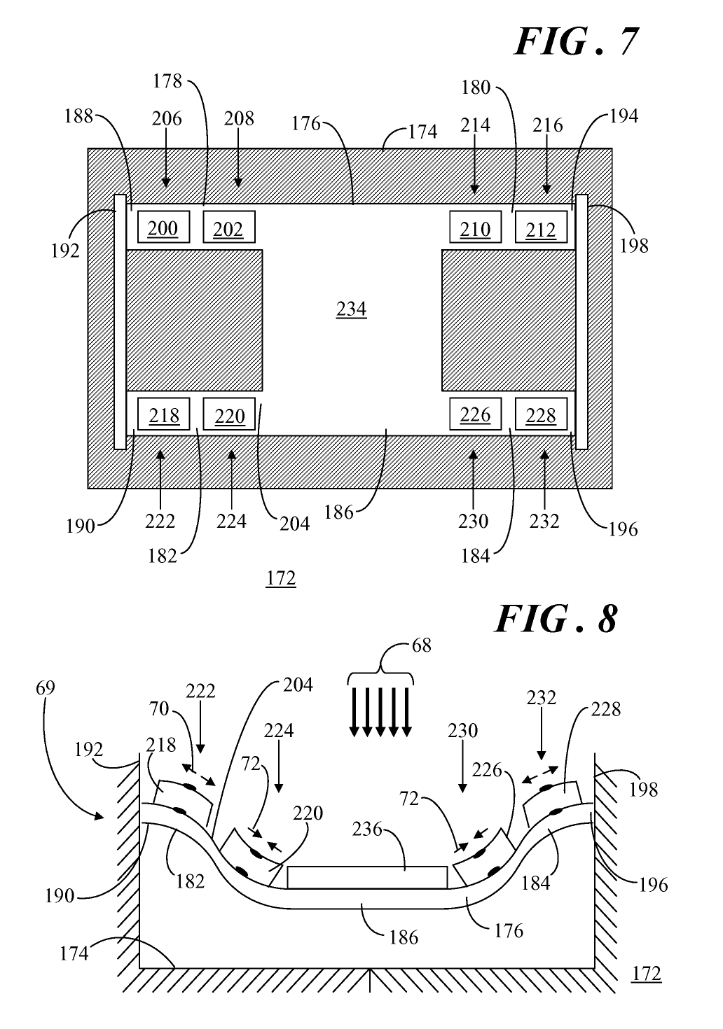

Referring to FIGS. 7 and 8, FIG. 7 shows a top view of a differential piezoelectric sensor 172 in accordance with another embodiment of the invention, and FIG. 8 shows a side view of differential piezoelectric sensor 172. In some instances, it may be desirable to add mass to a suspended bridge configuration in order to increase the deflection of the suspended structure and therefore increase sensitivity of the piezoelectric sensor and/or to alter the dynamics of the suspended structure in order to adjust the frequency response of the piezoelectric sensor. Embodiments of the invention may be adapted to include additional mass as well as multiple piezoelectric elements.

As shown, differential piezoelectric sensor 172 includes a substrate 174 and a suspended structure 176 coupled to substrate 174. In this illustrative embodiment, suspended structure 176 includes a first beam section 178, a second beam section 180, a third beam section 182, and a fourth beam section 184. An intermediate section 186 is coupled between beam sections 178, 180, 182, and 184 to form a unitary configuration for suspended structure 176. An end 188 of first beam section 178 and an end 190 of third beam section 182 are coupled to substrate 174 via an anchor 192. Likewise, an end 194 of second beam section 180 and an end 196 of fourth beam section 184 are coupled to substrate 174 via an anchor 198. Thus, suspended structure 176 is in an H-shaped geometric configuration having four connection points to the underlying substrate 174.

In an embodiment, piezoelectric elements 200 and 202 are located on a surface 204 of structure 176 at respective locations 206 and 208 on first beam section 178. Similarly, piezoelectric elements 210 and 212 are located on surface 204 of structure 176 at respective locations 214 and 216 on second beam section 180. Piezoelectric elements 218 and 220 are located on surface 204 at respective locations 222 and 224 on third beam section 182, and piezoelectric elements 226 and 228 are located on surface 204 at respective locations 230 and 232 on fourth beam section 180. As discussed in connection with previous embodiments, each of piezoelectric elements 200, 202, 210, 212, 218, 220, 226, and 228 have respective outer and inner electrodes which are not enumerated for simplicity of illustration.

Intermediate section 186 includes a mass element 234. Mass element 234 functions to reduce the flexibility of intermediate section 186 relative to the flexibility of beam sections 178, 180, 182, and 184. That is, intermediate section 186 flexes little as compared to the flexion of beam sections 178, 180, 182, and 184. This results in the presence of both the first stress state, e.g., tensile stress state 70, and the second stress state, e.g., compressive stress state 72, in each of beam sections 178, 180, 182, and 184.

In an embodiment, mass element 234 of intermediate section 186 is simply the central portion of suspended structure 176. The larger width of intermediate section 186 relative to the individual widths of each of beam sections 178, 180, 182, and 184 may be sufficient to increase the stiffness of intermediate section 186 relative to beam sections 178, 180, 182, and 184. However, in alternative embodiments, mass element 234 may be formed through the deposition of films onto intermediate section 186 that are already being used to form, for example, the electrodes and/or the piezoelectric elements, in order to increase the mass and stiffness of intermediate section 186 relative to beam sections 178, 180, 182, and 184.

As shown in exaggerated form in FIG. 8, when sensor 172 is subjected to external stimulus 68, beam sections 178 (not visible), 180 (not visible), 182, and 184 will move into stress position 69. That is, beam sections 178, 180, 182, and 184 will tend to flex or bend in response to external stimulus 68. Due to the coupling of ends 188, 190, 194, and 196 of suspended structure 176 to substrate 174 via anchors 192 and 196, as well as the inclusion of mass element 234, regions on each of beam sections 178, 180, 182, and 184 will be in a tensile stress state 70 (represented by a pair of arrows facing away from one another), and other regions on each of beam sections 178, 180, 182, and 184 will be in compressive stress state 72 (represented by a pair of arrows facing one another) when suspended structure 176 is in stress position 69. With external stimulus 68 in the downward direction as shown, locations 206, 216, 222, and 232 on surface 204 of suspended structure 176 are in tensile stress state 70 and locations 208, 214, 224, and 230 are in compressive stress state 72. Accordingly, piezoelectric elements 200, 212, 218, and 228 are in tension and piezoelectric elements 202, 210, 220, and 226 are in compression with application of external stimulus 68 in the illustrated orientation.

Since piezoelectric elements 200, 212, 218, and 228 are in tension and piezoelectric elements 202, 210, 220, and 226 are in compression, their generated output voltage signals will be opposite in polarity. In accordance with embodiments described above, their corresponding outer and inner electrodes are appropriately electrically coupled to obtain a common, i.e., the same, polarity for each of the voltage signals from piezoelectric elements 200, 202, 210, 212, 218, 220, 226, and 228 so that each of the voltage signals are combined by adding the voltage signals, as discussed in connection with FIG. 3. Alternatively, their corresponding outer and inner electrodes may be appropriately electrically coupled to obtain a common, i.e., the same, polarity for each of the current signals from piezoelectric elements 200, 202, 210, 212, 218, 220, 226, and 228 so that each of the current signals are combined by adding the current signals, as discussed in connection with FIG. 4.

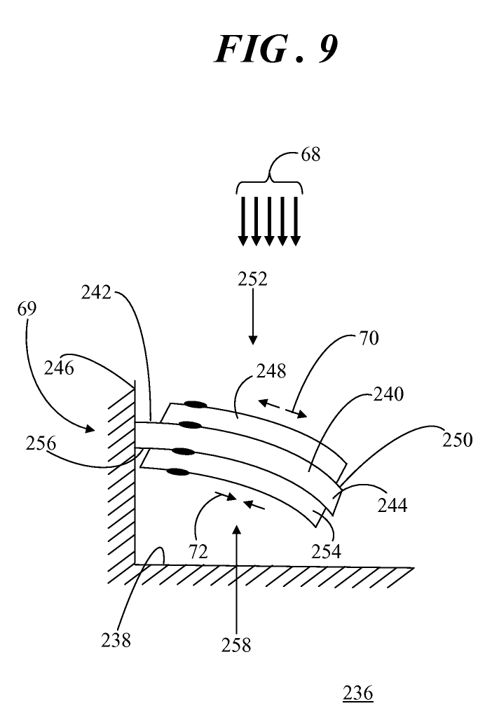

FIG. 9 shows a side view of a differential piezoelectric sensor 236 in accordance with another embodiment of the invention. In some instances, it may be desirable to implement a single point connection of a suspended structure, i.e. a cantilever configuration. Embodiments of the invention may be adapted to include multiple piezoelectric elements in a cantilever-type suspended structure.

In the illustrated embodiment, differential piezoelectric sensor 236 includes a substrate 238 and a suspended structure 240 coupled to substrate 238. In this illustrative embodiment, suspended structure 240 is a beam structure having ends 242 and 244. However, only end 242 is coupled to substrate 238 via an anchor 246 while end 244 is free from, i.e., unattached to, the underlying substrate 238 so that suspended structure 240 is spaced apart from substrate 238 in a cantilever beam configuration. A piezoelectric element 248 is located on a top surface 250 of structure 240 at a location 252 and another piezoelectric element 254 is located on a bottom surface 256 of structure 240 at a location 258. As discussed in connection with previous embodiments, each of piezoelectric elements 248 and 254 has respective outer and inner electrodes which are not enumerated for simplicity of illustration.

As shown in exaggerated form in FIG. 9, when sensor 236 is subjected to an external stimulus 68, the cantilever beam configuration of suspended structure 240 will move into stress position 69. That is, the cantilever beam configuration of suspended structure 240 will flex or bend in response to external stimulus 68, thus resulting in stress position 69 of suspended structure 240. Due to the coupling of end 242 of suspended structure 240 to substrate 238 via anchor 246, substantially the entire length of top surface 250 will be in the first stress state, e.g., tensile stress state 70 (represented by a pair of arrows facing away from one another), and substantially the entire length of bottom surface 256 will be in the second stress state, e.g., compressive stress state 72 (represented by a pair of arrows facing one another). Thus, with external stimulus oriented in the downward direction as shown, location 252 on top surface 250 is in tensile stress state 70 and location 258 on bottom surface 256 is in compressive stress state 72. Accordingly, piezoelectric element 248 is in tension and piezoelectric element 254 is in compression with application of external stimulus 68.

Since piezoelectric element 248 is in tension and piezoelectric element 254 is in compression, their generated output voltage signals will be opposite in polarity. In accordance with embodiments described above, their corresponding outer and inner electrodes are appropriately electrically coupled to obtain a common, i.e., the same, polarity for each of the voltage signals from piezoelectric elements 248 and 254 so that each of the voltage signals will combine by addition, rather than cancellation, as discussed in connection with FIG. 3. Alternatively, their corresponding outer and inner electrodes may be appropriately electrically coupled to obtain a common, i.e., the same, polarity for each of the current signals from piezoelectric elements 248 and 254 so that each of the current signals will combine by addition, rather than by cancellation, as discussed in connection with FIG. 4.

Embodiments of the invention entail differential piezoelectric sensors in which sensor geometry is optimized to effectively increase sensor reliability, durability, and sensitivity relative to prior art designs. In particular, multiple piezoelectric elements are formed on a suspended structure in predetermined regions on the suspended structure of enhanced tensile stress or enhanced compressive stress when the suspended structure is in a stress position caused by an external mechanical stress. Electrodes for each of the multiple piezoelectric elements are appropriately differentially coupled to yield a common polarity, i.e., the same polarity, for each of the voltage or current signals produced by each of the piezoelectric elements. These signals can subsequently be added to obtain an output signal representative of the mechanical stress experienced by the flexible suspended structure.

Although the preferred embodiments of the invention have been illustrated and described in detail, it will be readily apparent to those skilled in the art that various modifications may be made therein without departing from the spirit of the invention or from the scope of the appended claims. For example, the piezoelectric sensors are described as being fabricated in accordance with microfabriction and semiconductor processing techniques. However, the invention may be adapted for those piezoelectric sensors that are not miniaturized or are fabricated utilizing different techniques.

What is claimed is:

1. A piezoelectric sensor comprising:
a substrate;
a suspended structure coupled to said substrate, said suspended structure having a first location in a first stress state when said suspended structure is in a stress position, and said suspended structure having a second location in a second stress state when said suspended structure is in said stress position, said second stress state being opposite said first stress state;
a first piezoelectric element located at said first location, said first piezoelectric element producing a first signal in response to mechanical stress experienced by said suspended structure when said suspended structure is in said stress position; and
a second piezoelectric element located at said second location, said second piezoelectric element producing a second signal in response to said mechanical stress, and said second piezoelectric element being electrically coupled with said first piezoelectric element to combine said first and second signals to obtain a signal representative of said mechanical stress.

2. A piezoelectric sensor as claimed in claim 1 wherein said suspended structure comprises a surface having said first and second locations, and each of said first and second piezoelectric elements is located on said surface at a respective one of said first and second locations.

3. A piezoelectric sensor as claimed in claim 1 wherein said suspended structure comprises:
a first surface having said first location at which said first piezoelectric element is located; and
a second surface opposing said first surface and having said second location at which said second piezoelectric element is located.

4. A piezoelectric sensor as claimed in claim 1 wherein said suspended structure includes a first end and a second end, each of said first and second ends being anchored to said substrate so that said suspended structure is spaced apart from said substrate.

5. A piezoelectric sensor as claimed in claim 5 wherein said suspended structure further comprises:
a first beam section proximate said first end;
a second beam section proximate said second end;
an intermediate section interposed between said first and second beam sections, said intermediate section including a mass element.

6. A piezoelectric sensor as claimed in claim 5 wherein said mass element has reduced flexibility relative to a flexibility of each of said first and second beam sections.

7. A piezoelectric sensor as claimed in claim 4 wherein:
said suspended structure further comprises:
a first beam section proximate said first end, said first and second piezoelectric elements being positioned on said first beam section at respective ones of said first and second locations;
a second beam section proximate said second end;
a third beam section coupled to said substrate;
a fourth beam section coupled to said substrate, each of said second, third, and fourth beam sections having a location in said first stress state when said suspended structure is in said stress position, and each of said second, third, and fourth beam sections having another location in said second stress state when said suspended structure is in said stress position; and
an intermediate section coupled between said first, second, third, and fourth beam sections to form a unitary configuration of said suspended structure; and
said piezoelectric sensor further comprises a plurality of piezoelectric elements positioned on said second, third, and fourth beam sections at each of said locations, each of said plurality of piezoelectric elements producing a signal in response to said mechanical stress, said each of said plurality of piezoelectric elements being electrically coupled with said first and second piezoelectric elements to obtain said signal.

8. A piezoelectric sensor as claimed in claim 1 wherein:
said suspended structure has a third location in one of said first and second stress states when said suspended structure is in said stress position; and
said piezoelectric sensor further comprises a third piezoelectric element located at said third location, said third piezoelectric element producing a third signal in response to said mechanical stress, said third piezoelectric element being electrically coupled with said first and second piezoelectric elements to combine said first, second, and third signals to obtain said signal.

9. A piezoelectric sensor as claimed in claim 1 wherein said suspended structure includes a first end and a second end, only said first end is anchored to said substrate so that a remainder of said suspended structure is spaced apart from said substrate, said first piezoelectric element is formed on a first surface of said suspended structure, and said second piezoelectric element is formed on a second surface of said suspended structure opposite said first surface.

10. A piezoelectric sensor as claimed in 1 wherein said first signal is a first output current, said second signal is a second output current, each of said first and second piezoelectric elements has a positive electrode and a negative electrode, and said first and second piezoelectric elements are electrically coupled in parallel such that said positive electrode of said first piezoelectric element is electrically coupled with said negative electrode of said second piezoelectric element, and said negative electrode of said first piezoelectric element is electrically coupled with said positive electrode of said second piezoelectric element so that said first and second output currents combine to obtain said signal.

11. A piezoelectric sensor as claimed in claim 1 wherein said first signal is a first output voltage, said second signal is a second output voltage, each of said first and second piezoelectric elements has a positive electrode and a negative electrode, and said first and second piezoelectric elements are electrically coupled in series such that said positive electrode of said first piezoelectric element is electrically coupled with said positive electrode of said second piezoelectric element so that said first and second output voltages combine to obtain said signal.

12. A piezoelectric sensor comprising:
a substrate;
a suspended structure having a first end and a second end, each of said first and second ends being anchored to said substrate so that said suspended structure is spaced apart from said substrate, said suspended structure including a first beam section proximate said first end, a second beam section proximate said second end, and an intermediate section interposed between said first and second beam sections, said intermediate section including a mass element, wherein said suspended structure has a first location on one of said first and second beam sections in a first stress state when said suspended structure is in a stress position, and said suspended structure has a second location on one of said first and second beam sections in a second stress state when said suspended structure is in said stress position, said second stress state being opposite said first stress state;
a first piezoelectric element located at said first location, said first piezoelectric element producing a first signal in response to mechanical stress experienced by said suspended structure when said suspended structure is in said stress position; and
a second piezoelectric element located at said second location, said second piezoelectric element producing a second signal in response to said mechanical stress, and said second piezoelectric element being electrically coupled with said first piezoelectric element to combine said first and second signals to obtain a signal representative of said mechanical stress.

13. A piezoelectric sensor as claimed in claim 12 wherein said suspended structure comprises a surface having said first and second locations, and each of said first and second piezoelectric elements is located on said surface at a respective one of said first and second locations.

14. A piezoelectric sensor as claimed in claim 12 wherein said suspended structure comprises:
a first surface having said first location at which said first piezoelectric element is located; and
a second surface opposing said first surface and having said second location at which said second piezoelectric element is located.

15. A piezoelectric sensor as claimed in 12 wherein said first signal is a first output current, said second signal is a second output current, each of said first and second piezoelectric elements has a positive electrode and a negative electrode, and said first and second piezoelectric elements are electrically coupled in parallel such that said positive electrode of said first piezoelectric element is electrically coupled with said negative electrode of said second piezoelectric element, and said negative electrode of said first piezoelectric element is electrically coupled with said positive electrode of said second piezoelectric element so that said first and second output currents combine to obtain said signal.

16. A piezoelectric sensor as claimed in claim 12 wherein said first signal is a first output voltage, said second signal is a second output voltage, each of said first and second piezoelectric elements has a positive electrode and a negative electrode, and said first and second piezoelectric elements are electrically coupled in series such that said positive electrode of said first piezoelectric element is electrically coupled with said positive electrode of said second piezoelectric element so that said first and second output voltages combine to obtain said signal.

17. A piezoelectric sensor comprising:
a substrate;
a suspended structure having a first end and a second end, each of said first and second ends being anchored to said substrate so that said suspended structure is spaced apart from said substrate, said suspended structure having a first location on a surface of said suspended structure, said first location being in a first stress state when said suspended structure is in a stress position, and said suspended structure having a second location on said surface of said suspended structure, said second location being in a second stress state when said suspended structure is in said stress position, said second stress state being opposite said first stress state;
a first piezoelectric element located at said first location, said first piezoelectric element producing a first signal in response to mechanical stress experienced by said suspended structure when said suspended structure is in said stress position; and
a second piezoelectric element located at said second location, said second piezoelectric element producing a second signal in response to said mechanical stress, and said second piezoelectric element being electrically coupled with said first piezoelectric element to combine said first and second signals to obtain a signal representative of said mechanical stress.

18. A piezoelectric sensor as claimed in claim 17 wherein said suspended structure further comprises:
a first beam section proximate said first end;
a second beam section proximate said second end;
an intermediate section interposed between said first and second beam sections, said intermediate section including a mass element.

19. A piezoelectric sensor as claimed in claim 18 wherein:
said suspended structure has a third location in one of said first and second stress states when said suspended structure is in said stress position; and
said piezoelectric sensor further comprises a third piezoelectric element located at said third location, said third piezoelectric element producing a third signal in response to said mechanical stress, said third piezoelectric element being electrically coupled with said first and second piezoelectric elements to combine said first, second, and third signals to obtain said signal.

20. A piezoelectric sensor as claimed in claim 19 wherein said suspended structure includes a second surface opposing said surface, said second surface having said third location at which said third piezoelectric element is located.
